(19) United States
(12) Patent Application Publication
(10) Pub. No.: US 2018/0078086 A1
(43) Pub. Date: Mar. 22, 2018

(54) BEVERAGE PREPARATION MACHINE

(71) Applicant: DELICA AG, Birsfelden (CH)

(72) Inventors: Roland AFFOLTER, Möriken (CH); Markus BRÖNNIMANN, Hermrigen (CH); Miles ZHAO, Shenzhen City (CN)

(21) Appl. No.: 15/564,435

(22) PCT Filed: Mar. 22, 2016
(86) PCT No.: PCT/EP2016/056243

§ 371 Date: Oct. 5, 2017

(30) Foreign Application Priority Data
Apr. 8, 2015 (CH) 488/15

(51) Int. Cl. A47J 31/46

(52) U.S. Cl. CPC A47J 31/46

(57) ABSTRACT

The invention relates to a beverage preparation machine, particularly a coffee machine, which comprises two brewing chambers for receiving a beverage substrate for extraction, and a valve for switching a liquid supply to the individual brewing chambers, said valve being a membrane valve and comprising an inlet opening for the liquid supply, a first outlet opening for the first brewing chamber, a second outlet opening for the second brewing chamber, and a closing membrane.

The present invention relates to a beverage preparation machine, more particularly a coffee machine, with two brewing chambers according to the preamble of claim 1.

A number of beverage preparation machines are already known from the prior art which to prepare a mixed beverage, by way of example in the form of a milky coffee or a cappuccino, are able to receive two different capsules which are processed simultaneously and/or sequentially. Valves are required for supplying the two brewing chambers with the required amount of water. Normally hose pinch valves, magnetic valves or ceramic valves are used.

EP 1 961 351 B1 by way of example describes a coffee machine with two brewing chambers which can be operated sequentially. A two-way ceramic valve is used to switch the water supply from a first brewing chamber over to the second brewing chamber. The document furthermore mentions magnetic valves which can be used in place of the ceramic valve.

The drawback with the prior art is that the valves fur up and thus the sealing action of the valves is very quickly impaired. This problem was indeed solved with hose-pinching valves but with each closing process these are subjected to high mechanical loads so that only a short service life can be obtained.

It is the object of the invention to overcome the disadvantages of the prior art. More particularly a beverage preparation machine is to be provided with two brewing chambers which can be controlled with a reliable valve. A valve is also to be provided having a low number of movable parts.

This is achieved by a beverage preparation machine having the features of claim 1. Further embodiments are apparent from the dependent patent claims.

By beverage preparation machine is meant more particularly a machine which using portion capsules can produce any type of liquid food or beverage. It is not differentiated here whether the prepared foodstuff is coffee, tea, milk-containing products, instant soups, baby food or power drinks. It concerns more particularly however a machine which prepares a liquid foodstuff based on a portion capsule, which contains a food substance, by injecting a liquid into the capsule and extracts, brews, dissolves etc. the food substance. By capsule is meant more particularly also a pod.

A beverage preparation machine, more particularly coffee machine, according to the invention comprises two brewing chambers for receiving a beverage substrate and a valve for switching over a liquid supply to the individual brewing chambers. The valve is a membrane valve with a closure membrane and has an inlet opening for supplying the liquid, as well as a first and a second outlet opening for the first and second brewing chambers.

By using a membrane valve it is possible to achieve a very commercially viable valve solution. Membrane valves are furthermore not sensitive to furring up. The movement of the membrane prevents limescale from settling. Since membrane valves normally only execute a very small stroke the wear on the membrane is very low and long service lives can be ensured. Furthermore in a membrane valve normally only the membrane comes into contact with the liquid flow being regulated so that only abrasion or wear from the membrane can contaminate the liquid flow.

The brewing chambers can be configured for directly receiving a beverage substrate or however for receiving a corresponding portion capsule. It is likewise conceivable that the machine has a number of brewing chambers, and correspondingly the valve has not only two outlet openings but a corresponding number of outlet openings.

The valve can have for each outlet opening a tappet with which the closing membrane can be pressed onto the corresponding outlet opening and thus close it. By using individual tappets for closing the outlet openings it is also possible to control the valve individually. Thus it is conceivable by way of example that the valve with two outlet openings has four different settings; both outlet openings open, both outlet openings closed, a first outlet opening open and second outlet opening closed, first outlet opening closed and second outlet opening open. The use of tappets furthermore allows careful control and operation of the closing membrane. Friction forces can in particular be eliminated. The closing membrane is only deflected and slightly expanded. The closing membrane is charged with additional pressure depending on the contact pressure of the tappets. Alternatively the closing membrane can also be deflected directly or indirectly by means of a cam disk, cam shaft or other means.

The tappets can be movably mounted in a guide element. A guide element acts so that the tappets can only be moved in a defined direction. It is thus ensured by way of example that a base surface of the tappets is arranged parallel to a sealing face of the outlet openings and remains in parallel alignment during movement of the tappet. Mechanical stress on the closing membrane is also kept low correspondingly.

The valve can have a cam disk for controlling the tappets. The individual tappets can be moved very easily by means of a cam disk. The cam disk for controlling the tappets can be mounted for rotational movement in the valve. Instead of a cam disk it is also possible to use a cam shaft or other actuating elements. A cam disk is however a very cost-effective solution and can be simply controlled by means of gearing. The cam disk can have an axis of rotation roughly parallel to a direction of movement of the tappets.

The valve can have a two-part housing, wherein a first housing part preferably comprises a distributor plate in which both the inlet opening and also the outlet openings are formed and preferably also corresponding hose connections are arranged. The second housing part can comprise fixing means in order to be able to fix the valve in a beverage preparation machine. Fixing means of this kind can be by way of example snap fittings or screw fittings. The valve can have hose connections with an interface which enables a rapid and simple change of the hoses. By way of example each hose end can be fitted with an adaptor which can be coupled to the interface of the hose connection.

The valve can comprise a first and a second passage position in which the first and/or the second outlet opening are open. Correspondingly the individual brewing chambers connected to the outlet openings can be supplied individually or simultaneously with water.

The passage positions can be configured so that in the first passage position only the first outlet opening is open and in the second passage position only the second outlet opening is open. It can thus be ensured that in each case only one brewing chamber is supplied with water. A simultaneous brewing of a beverage in both brewing chambers is thus prevented. Correspondingly it can also be ensured that in each brewing chamber the required extraction pressure is applied which is produced by a pump connected in on the input side of the valve. A configuration of this kind is advantageous if a sequential preparation is required in order to produce by way of example a layered beverage.

The valve can comprise a closing position in which all the outlet openings are closed. A configuration of this kind means that at the end of the brewing process no more liquid can drip into the brewing chambers. This prevents accordingly any undesired soiling of the beverage preparation machine or unnecessary filling of a drip device. It furthermore also prevents liquid from passing from the brewing chamber into the valve and contaminating the latter. This is an essential hygiene feature particularly for preparing milk-containing beverages since the valve cannot be cleaned by the user or can only be cleaned with considerable effort.

The valve can be a safety valve and have a structure which can be opened under a predetermined pressure. By way of example it is thus possible to prevent a blocked brewing chamber resulting in damage to the pump or the entire machine. The valve can then be configured by way of example so that it seals reliably up to a pressure of 18 bar, and from a pressure between 20 and 25 bar opens independently of its setting in order to reduce the pressure again. By way of example the closing membrane can be configured compressible. The sealing action can thus be controlled using the contact pressure on a sealing surface. Even with a closed valve the closing membrane can be compressed by excess pressure in the valve so that an outlet opening which is actually closed then opens. By way of example in the closing position of the valve, thus with all the outlet openings closed, the contact pressure of the tappet on the closing member is less than the contact pressure of the tappet in the case of an outlet opening which is only open on one side. Thus a stepped safety function can be achieved. By way of example relieving the valve which is closed on all sides can already take place with a pressure of 5 to 8 bar. This is advantageous so that the pressure in the valve and correspondingly in a pump and a heater of the machine can be reduced after their use. Nevertheless the closed valve prevents dripping once the brewing process has been completed. With an outlet opening which is only open on one side the safety function can only respond later on when the contact pressure of the tappet is greater. Thus brewing or extracting the beverage is possible under a high pressure up to 18 bar by way of example. Only on reaching or exceeding the pressure of 20 to 25 bar does a closed outlet opening become permeable.

A flat sealing surface can be arranged circumferentially around each outlet opening. A flat sealing surface of this kind ensures that the closing membrane which is pressed by a tappet onto this sealing surface bears uniformly against this surface and closes the outlet opening. Through the flat configuration the tappet can also have a base surface which comprises a flat surface. Flat surfaces of this kind are easier to produce. A good sealing action is correspondingly possible.

The sealing surface can by way of example have a diameter which is smaller than or equal to a diameter of a base surface of the corresponding tappet. It is thus also conceivable that the diameter of the base surface of the tappet is configured smaller than the diameter of the sealing surface. It should be noted however that the base surface of the tappet is to rest at least on the sealing surface and is correspondingly larger than the diameter of the outlet opening. The sealing surface and the base surface of the tappet must overlap. The tolerances when manufacturing the valve are thus less critical and can be selected correspondingly greater. The sealing surface and the base surface of the tappet lie correspondingly in planes which are preferably aligned parallel to one another.

Alternatively it would also be conceivable that the tappet is configured so that this can penetrate at least partially into the outlet opening. The sealing action of the closing membrane is thus no longer on a flat sealing surface but rather is closed on a sealing surface which is located in the inlet region of the outlet opening and has by way of example a conical configuration.

The valve can be displaced mechanically by a user by way of a drive lever. The mechanical adjustability enables a very simple structure of the valve. More particularly the valve is less susceptible to breakdown since no electrical and/or electronic components are used for controlling the valve.

The drive lever can be connected by way of example directly to the cam disk of the valve. Thus a movement of the drive lever acts directly on the cam disk which in turn controls the tappet of the valve.

The drive lever can be coupled mechanically to a control element of a user interface of the machine. The control element can then be arranged and mounted on the beverage preparation machine in a linearly displaceable manner. Beverage preparation machines normally have a user interface by means of which a user sets the type of beverage required or at least switches on the machine. A very simple and reliable control of the valve can in turn be achieved through a mechanical coupling with a corresponding control element of a user interface.

The control element can be mounted on the beverage preparation machine so as to be displaceable in a direction which is aligned substantially parallel to a moving plane of a lever which is normally used and is to be actuated by a user to close the brewing chambers. More particularly the control element can then be arranged within reach of the lever so that the user can in an ergonomic hand movement actuate the lever and operate the control element simultaneously or directly one after the other.

The control element can be combined with a machine control. It is thus possible to also control the beverage preparation only with a single control element which directly controls the valve setting. By way of example, by moving the control element from a middle position it is possible to wake up the beverage preparation machine from a standby mode and by displacing the control element up to a stop where the valve is correctly adjusted to trigger a brewing process. It is self-evident that for the brewing process a pump and where applicable a heater have to be brought into operation. The machine can have here a through-flow meter which switches off the pump again after a predetermined amount of liquid has been supplied. Alternatively the pump can also be switched off however by the user by resetting the control element back to the middle position.

The drive lever can have a toothed segment which engages in a toothed rod of the control element. A coupling via a toothed segment/toothed rod combination is a very reliable type of structure and in particular is easy to create. Undesired slip is furthermore prevented.

The cam disk of the valve can alternatively be driven by an electric motor having a corresponding gear and a position recognition for correctly adjusting the valve settings. By way of example a servo motor or a stepper motor can be used. Through an electromechanical solution of this kind it is possible to install the valve at any point in the machine. The valve can nevertheless be controlled by the control element which is arranged on the user interface of the machine. It is self-evident that the control element must have corresponding switching contacts in order to actuate the control of the valve.

The closing membrane can contain a compressible material, more particularly a silicon material or an ethylene-propylene-diene rubber (EPDM). More particularly the closing membrane can also be made from the compressible material. Materials of this kind are food-compliant and nevertheless have good properties as regards the sealing function.

The invention will now be explained in further detail using the figures which show only exemplary embodiments. In the drawings:

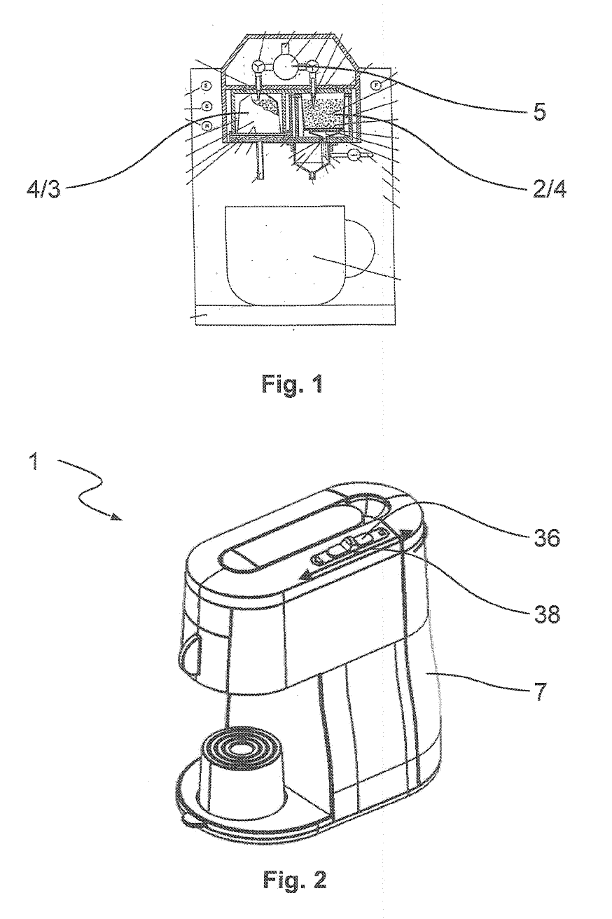

FIG. 1: shows a diagrammatic view of a beverage preparation machine with two brewing chambers and a switching valve of the prior art;

FIG. 2: shows a perspective view of a beverage preparation machine according to the invention;

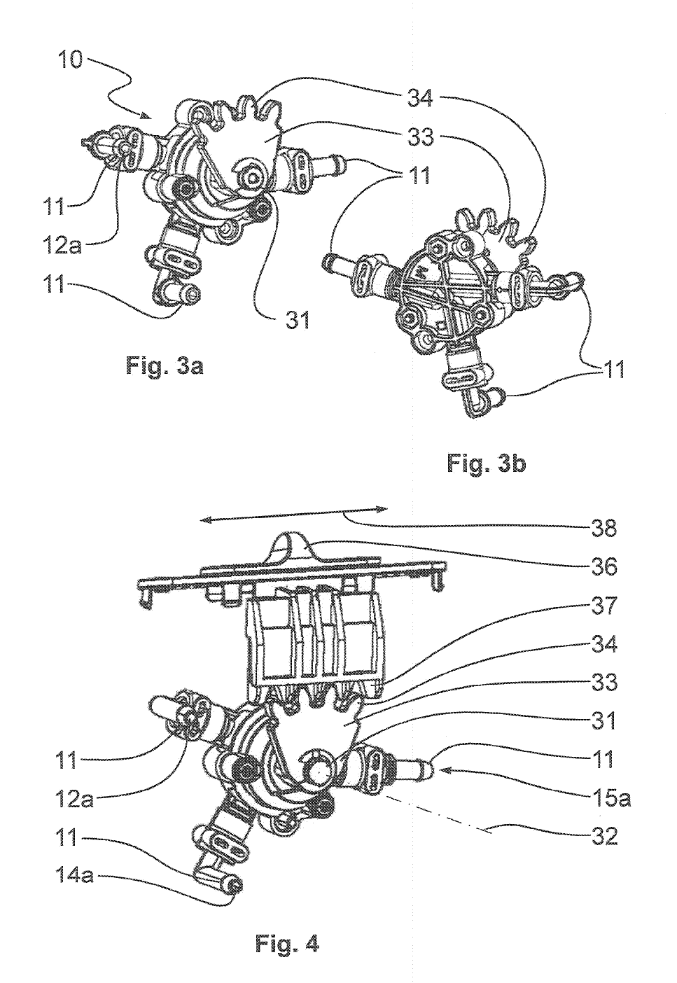

FIG. 3a: shows a perspective view of a valve of the beverage preparation machine of FIG. 2;

FIG. 3b: shows the valve of FIG. 3a in a different perspective view;

FIG. 4: shows in a perspective view the valve of FIG. 3 with a control element of the beverage preparation machine according to FIG. 2;

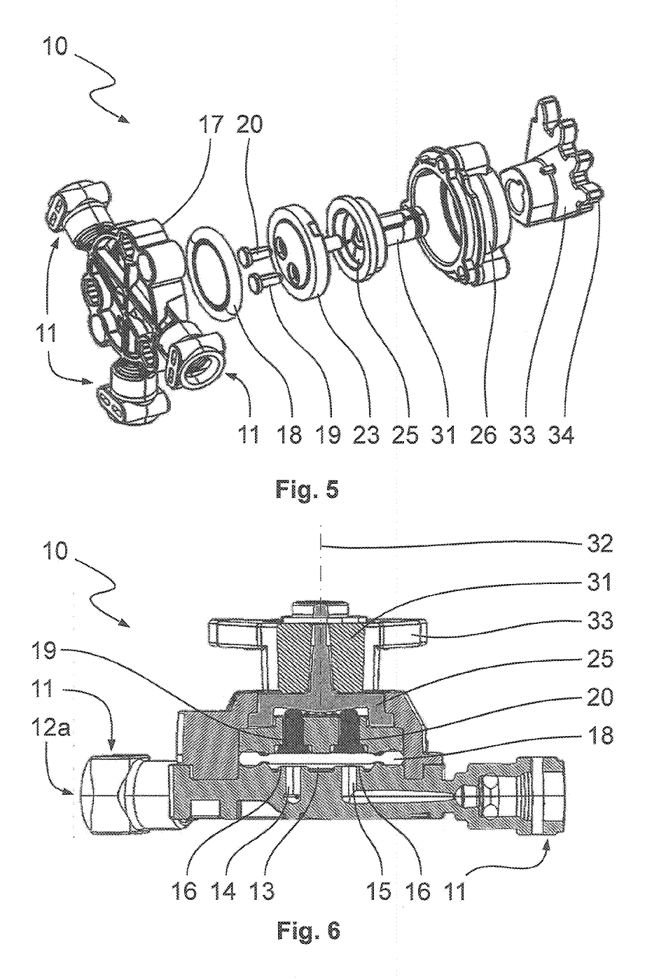

FIG. 5: shows the valve of FIG. 3 in an exploded illustration;

FIG. 6: shows the valve of FIG. 3 in a cross section through the tappet;

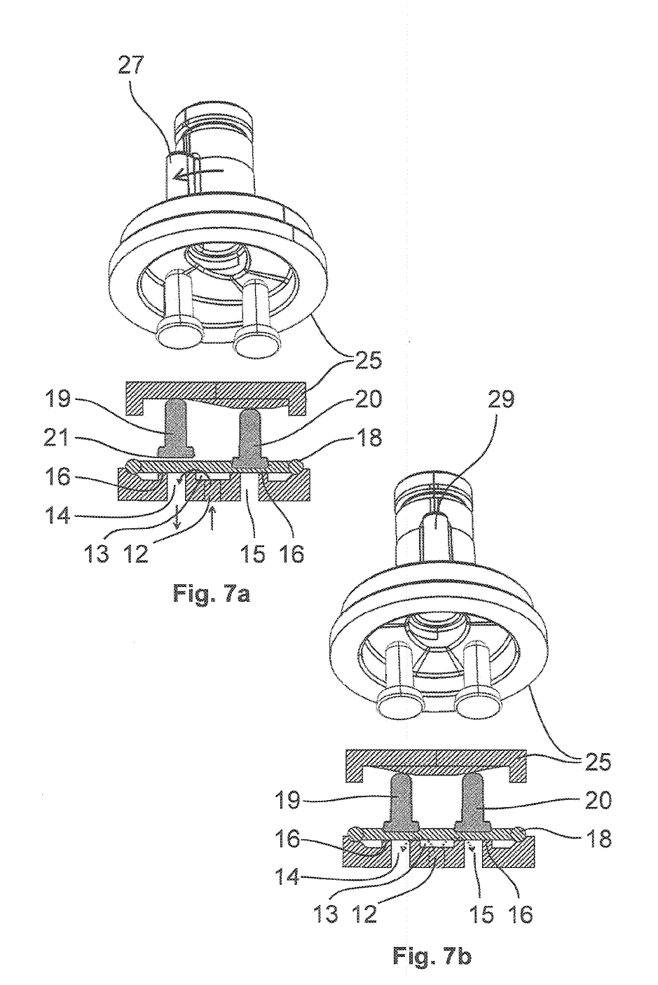

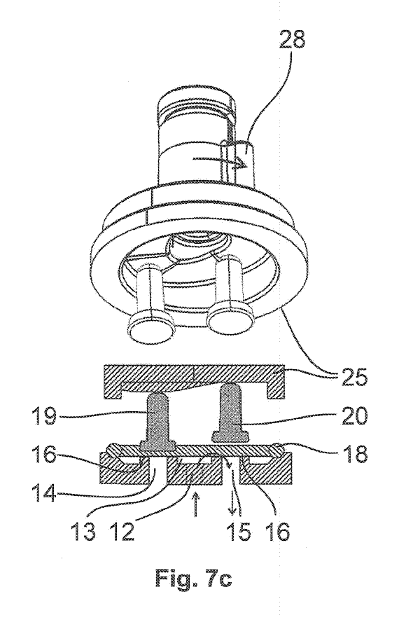

FIG. 7a: shows a diagrammatic view of the valve in the cross section of FIG. 6 in a first passage position;

FIG. 7b: shows the valve of 7a in a closed position;

FIG. 7c: shows the valve of FIG. 7a in a second passage position.

FIG. 1 shows a diagrammatic illustration of a beverage preparation machine with two brewing chambers 2, 3 and a switching valve 5 of the prior art. A capsule containing a beverage substrate 4 is contained in each of the brewing chambers 2, 3. Both brewing chambers have an injector which injects the liquid into the corresponding brewing chamber and corresponding capsule. The injectors are connected to the switching valve 5 which controls the water supply to the individual brewing chambers 2, 3.

FIG. 2 shows a perspective view of a beverage preparation machine 1 according to the invention. The beverage preparation machine 1, like the beverage preparation machine in FIG. 1 comprises two brewing chambers (not shown) which can be controlled individually. For this the beverage preparation machine 1 has a control element 36 by way of which the corresponding brewing chamber can be selected. For this the control element 36 is mounted displaceable in a direction of movement 38 on the surface of the beverage preparation machine 1. Depending on the position of the control element 36, water is directed from a water tank 7 via an optional water heater, a pump and a membrane valve 10 (see FIGS. 3 to 7) into the corresponding brewing chamber.

FIGS. 3a and 3b show a membrane valve 10 of the beverage preparation machine 1 according to the invention in FIG. 2 in two different perspective views. The membrane valve 10 has three hose connections 11 wherein one hose connection is for an inlet channel 12a, and two hose connections are for a first and a second outlet channel 14a, 15a (see FIG. 4). The inlet channel 12a leads here to an inlet opening 12 and the first and second outlet channels 14a, 15a each lead to a first and second outlet opening 14, 15 respectively (see FIGS. 7a to 7c). The membrane valve 10 has a drive lever 33 which is provided with a toothed segment 34 and sits on a drive shaft 31 of the membrane valve 10. By displacing the drive lever 33 and/or by rotating the drive shaft 31 the inlet opening and thus the inlet channel 12a can be connected to the first outlet opening or to the second outlet opening.

FIG. 4 shows in turn the membrane valve of FIG. 3, wherein additionally the control element 36 of the machine according to the invention in FIG. 2 is also shown. Three hose connections 11 as well as the inlet channel 12a and the outlet channels 14a, 15a can again be seen. The control element 36 can be displaced in the direction of movement 38. The control element 36 has here a toothed rod 37 which interacts with the drive lever 33 and the corresponding toothed segment 34. The drive lever 33 is thus turned about the axis of rotation 32 through moving the control element 36. This rotation is transferred to the drive shaft 31 of the membrane valve so that the membrane valve can be moved by way of example from a closed position 29 into a first passage position 27 or a second passage position 28 (see FIGS. 7a to 7c).

FIG. 5 shows the membrane valve 10 of FIG. 3 in an exploded view. The three hose connections 11 are again shown which form the inlet channel 12a and the two outlet channels. The hose connections 11 are each provided with an interface which enables simple replacement of the hose. These hose connections 11 are integrated in a distributor plate 17. The membrane valve 10 further has a closing membrane 18 which serves to close the two outlet openings 14, 15 (see FIG. 6) on the inside of the distributor plate 17. The closing membrane 18 is configured substantially as a flat circular membrane with a circumferential bead. This closing membrane 18 is deflected by means of two tappets 19, 20 which are mounted displaceably in a guide element 23. The two tappets 19, 20 are driven here by a cam disk 25. The cam disk 25 has a drive shaft 31 which is connected secured against rotation to the drive lever 33 as shown in FIG. 4. The drive lever 33 has a toothed segment 34. The membrane valve 10 is enclosed by a valve housing 26 and the distributor plate 17. The closing membrane 18 then not only seals the individual outlet openings 14, 15 but also at the same time with its circumferential bead together with the guide element 23 ensures sealing of the valve chamber 13 (see FIG. 6). The control movements of the tappets 19, 20 and the cam disk 25 take place accordingly absolutely dry so that there is no contamination of the brewing water from frictional wear or the like.

FIG. 6 shows the membrane valve 10 in a cross section through the tappets 19, 20 wherein the section does not run centrally through the drive shaft 31. The drive lever 33 sits on the drive shaft 31 of the cam disk 25 which defines the axis of rotation 32. The cam disk 25 has a structure with ramps, the actual cams, which move the tappets 19, 20 out from their rest position. In the illustrated view the two tappets 19, 20 are located in a rest position. The two tappets 19, 20 are in active connection with the closing membrane 18 in order to be able to deflect this accordingly. Underneath the closing membrane 18 there is a valve chamber 13 which is filled with brewing water through the inlet channel 12a via the hose connection 11. Depending on the position of the tappets 19, 20 the membrane 18 is pressed onto a sealing surface 16 of the first outlet opening 14 or the second outlet opening 15. This sealing surface 16 is in the case of both outlet openings 14, 15 arranged in one plane in annular fashion around the outlet openings 14, 15. The sealing surfaces 16 represent a bearing surface on which the membrane 18 can be pressed with the tappets 19, 20.

FIGS. 7a to 7c show in a diagrammatic cross section the function of the membrane valve 10 of FIG. 6 in different positions wherein the corresponding position of the cam disk 25 is shown in each case in a perspective view. The membrane valve 10 in FIG. 7a is located in a first passage position 27. The control disk 25 correspondingly presses with its cam onto the tappet 20 which in turn deflects the closing member 18 and presses on the sealing surface 16 of the second outlet opening 15. The second outlet opening 15 is thus closed. The valve chamber 13 is filled through the inlet opening 12 with a liquid, preferably water from a pump so that the closing membrane 18 can be lifted from the sealing surface 16 of the first outlet opening 14. The tappet 19 is located in its rest position in which the cam of the cam disk 25 is not operating. The tappet 19 can rather rest by its base surface 21 on the closing membrane 18, but does not press this onto the sealing surface 16 of the first outlet opening 14. With internal pressure a fluid connection is correspondingly present between the inlet opening 12 and the first outlet opening 14. This fluid connection is shown by means of arrows.

In FIG. 7b the membrane valve 10 is located in the closing position 29. The cam of the cam disk 25 acts correspondingly on both tappets 19, 20. The closing membrane 18 is pressed by these two tappets 19, 20 onto the respective sealing surfaces 16 of the first and second outlet opening 14, 15. The outlet openings 14, 15 are thus closed. Even if a pressurised liquid presses through the inlet opening 12 into the valve chamber 13 the two outlet openings 14, 15 remain closed up to a certain point. The cam of the cam disk 25 is thus configured so that the tappets 19, 20 are not fully deflected. With an unexpected excess pressure in the region of 5 to 8 bar the membrane 18 can be correspondingly compressed and lifted. The excess pressure can be dissipated through the two outlet openings 14, 15. This is shown in the figure by the dotted arrows.

FIG. 7c now shows the membrane valve 10 in the second passage position 28. The cam disk 25 presses with its cam onto the tappet 19 which in turn presses the closing membrane 18 onto the sealing surface 16 of the first outlet opening 14. The outlet opening 14 is thus closed. The tappet 20 is located in the rest position and the closing membrane 18 is lifted through the pressure in the valve chamber 13 starting from the inlet opening 12 away from the sealing surface 16 of the second outlet opening 15. The second outlet opening 15 is thus opened. The corresponding fluid connection is shown by means of arrows.

In the two passage positions 27, 28 according to FIGS. 7a and 7c, one outlet opening 14 or 15 is open in each case whilst the other outlet opening is closed. Using a compressible closing membrane 18 provides a safety function. If by way of example in the event of the passage position 27 according to FIG. 7a, the outlet opening 14 which is actually open is shut or blocked then despite a completely deflected tappet 20 the closing membrane 18 can be further compressed by the internal pressure which is building up so that the excess pressure is limited and dissipated through the outlet opening 15 which is actually closed. Damage to the hoses, the pump, the heater or the machine can thus be prevented. Through a corresponding structural configuration and/or through the choice of the material properties of the valve membrane 18 it is possible to adjust the safety function so that this by way of example is only used with an excess pressure in the range from 20 to 25 bar. It can correspondingly be ensured that nevertheless an espresso can be extracted by way of example with a pressure of up to 18 bar. Other pressure values can obviously also be set however.

1-14. (canceled)

15. A beverage preparation machine comprising two brewing chambers for receiving a beverage substrate and a valve for switching over a liquid supply to the individual brewing chambers, wherein the valve is a membrane valve having an inlet opening for supplying the liquid, a first outlet opening for the first brewing chamber, a second outlet opening for the second brewing chamber and a closing membrane.

16. The beverage preparation machine as claimed in claim 15, wherein the valve has for each outlet opening a tappet with which the closing membrane can be pressed against the corresponding outlet opening.

17. The beverage preparation machine as claimed in claim 16, wherein the valve has a cam disc for controlling the tappets.

18. The beverage preparation machine as claimed in claim 17, wherein the cam disc is mounted rotatably in the valve for controlling the tappets.

19. The beverage preparation machine as claimed in claim 15, wherein the valve has a first and a second passage position in which either the first outlet opening or the second outlet opening or both outlet openings are open.

20. The beverage preparation machine as claimed in claim 19, wherein in the first passage position only the first outlet opening is open and in the second passage position only the second outlet opening is open.

21. The beverage preparation machine as claimed claim 15, wherein the valve has a closing position in which all the outlet openings are closed.

22. The beverage preparation machine as claimed in claim 15, wherein the valve is a safety valve and has a structure which can open in the event of a predetermined pressure.

23. The beverage preparation machine as claimed in claim 15, wherein a sealing surface running in one plane is arranged circumferentially around each outlet opening.

24. The beverage preparation machine as claimed in claim 23, wherein the sealing surface has a diameter which is less than or equal to a diameter of a base surface of a corresponding tappet.

25. The beverage preparation machine as claimed in claim 15, wherein the valve can be adjusted mechanically by a user via a drive lever.

26. The beverage preparation machine as claimed in claim 26, wherein the drive lever is coupled mechanically to a more particularly linearly displaceably mounted control element of a user interface.

27. The beverage preparation machine as claimed in claim 26, wherein the drive lever has a toothed segment which interacts with a toothed rod of the control element.

28. The beverage preparation machine as claimed in claim 17, wherein the cam disc of the valve can be driven by an electric motor with a gear and with a position recognition for correctly setting the valve positions.

29. The beverage preparation machine as claimed in claim 15, wherein the closing membrane comprises a compressible material.

30. The beverage preparation machine as claimed in claim 29, wherein the compressible material is a silicon material or an ethylene-propylene-diene rubber (EPDM).
